(19) United States
(12) Patent Application Publication
(10) Pub. No.: US 2008/0074427 A1
(43) Pub. Date: Mar. 27, 2008

(54) METHOD FOR DISPLAY OF MEDICAL 3D IMAGE DATA ON A MONITOR

(76) Inventor: Karl Barth, Hochstadt (DE)

Correspondence Address: SCHIFF HARDIN, LLP;PATENT DEPARTMENT, 6600 SEARS TOWER, CHICAGO, IL, 60606-6473, US

(21) Appl. No.: 11/861,428

(22) Filed: Sep. 26, 2007

(30) Foreign Application Priority Data
Sep. 26, 2006 (DE) 10 2006 045 402.2

(51) Int. Cl. G06F 15/16

(52) U.S. Cl. 345/502

(57) ABSTRACT

In a method for display of medical 3D image data on a monitor, a rotation center is established in the 3D image data and at least two windows with views of the 3D image data that differ per pair of windows are shown on the monitor. The views are arranged in the windows such that the imaging locations of the rotation center in respective windows lie over one another or next to one another relative to the monitor. A rotation axis intersecting the rotation center in the 3D image data is associated with each window. The view in the window is rotationally altered only by the 3D image data being rotated around the rotation axis associated with the window. The change of the view in a first of the windows is executed by operation of an operating element associated with a second of the windows.

### BACKGROUND OF THE INVENTION

1. Field of the Invention

The present invention concerns a method for display of medical 3D image data on a monitor.

2. Description of the Prior Art

Imaging medical-technical apparatuses such as, for example, x-ray, computed tomography systems, magnetic resonance imaging systems, ultrasound apparatuses and PET scanners are commonly used in medicine. The image data sets acquired with modern apparatuses exhibit a high resolution in the sub-millimeter range in all spatial directions, such that detailed 3D exposures from the acquired volume data sets are generated. Computed tomography (CT) or x-ray apparatuses thus can be used in an intensified manner since the radiation exposure that an organism is exposed to during an examination has decreased in such apparatuses. The volume data sets so generated exhibit a larger data content than the image data sets of conventional two-dimensional images. An evaluation of the image data sets is therefore relatively time-consuming. The actual acquisition of a corresponding volume data set as an isotropic 3D volume lasts approximately half a minute; the combing by binning and preparation of the volume data set often lasts half an hour or more. Improved presentation and interpretation aids are therefore necessary and welcome. An improved visualization for image-aided diagnosis and therapy planning should hereby be achieved.

Up until approximately 2000 it was typical in computer tomography (CT) to make a diagnosis using axial slice stacks (slice images) or at least for the viewer to orient himself or herself on the slice images for making a finding. Due to the increasing computing capacity of computers, the availability of 3D representations on diagnostic consoles has increased since approximately 1995. Initially, they had more of a scientific or supplementary importance.

In order to make the diagnosis easier for the physician, essentially four basic methods of 3D visualization have also been developed:

1. Multi-planar reformatting (MPR): This is basically a re-composition (recombination) of the volume data set in a different orientation than, for example, the original horizontal slices. Basically three techniques are used, namely orthogonal MPR (3 MPRs, respectively perpendicular to a coordinate axis), free MPR (angled slices; derived=interpolated) and curved MPR (slice generation parallel to an arbitrary path through the image (map) of the body of the organism and, for example, perpendicular to the MPR in which the path was drawn). Each image is thus reinterpreted or recreated from the 3D volume or block.

2. Shaded Surface Display (SSD): Segmentation of the volume data set and presentation of the surface of the excised subjects, mostly strongly pronounced via orientation on the CT values and manual auxiliary editing. For example, here only the bones of a patient might be segmented.

3. Maximum Intensity Projection (MIP): Presentation of the highest intensity along each ray (“ray” here meaning “point of view ray” or “povray”); for example, the brightest point is sought in each ray and only this is shown. In what is known as Thin MIP only a partial volume is shown.

4. Volume Rendering (VR): This is a modeling of the attenuation of the ray that penetrates into the subject in a manner comparable to an x-ray. The entire depth of the imaged body (translucent in part) is acquired, but details of shown subjects that are small and primarily composed of thin layers are therefore lost. The representation is manually affected by adjustment of features known as transfer functions (color look-up tables). These are, for example, selected by the mouse wheel of a computer mouse.

Another important type of fast visualization, but not an actual 3D method, is the film-like representation into a slice stack in which one slice is shown after the other (cine). This variant can also be realized in an MPR method by displacement of the slice surface.

As of the present time, such 3D representation methods still have not found complete acceptance, since primarily radiology is strongly “pre-influenced” by conventional, orthogonal slice direction. Furthermore, the necessity often arises in surgical planning (particularly orthopedic planning) to orient on planar, often orthogonal views of implants, such that here an adapted representation is likewise needed. Free 3D views available today are unknown or highly unfamiliar to most surgeons and radiologists. For example, it would normally be a burden for the physician to designate at which depth and in which orientation the slices are suitable for viewing.

If the medical imaging ensues in the context of the use of an implant or a prosthesis, its coordinates usually exist only as 2D coordinates. Since medical imaging increasingly ensues in 3D, a medical representation method of the image data must be viewed as a bridge between 2D and 3D. The presentation of the medical 3D image data on a monitor should thus allow an optimal adaptation of implants and prostheses in more than two dimensions with smooth transition, such that a surgical planning can ensue more completely and precisely in three dimensions than was previously possible in two dimensions or with the known 3D methods. For this purpose, two-dimensional subjects can be presented in 3D volumes, for example as subjects with an artificially-generated third dimension (for example voxel depth 1).

### SUMMARY OF THE INVENTION

An object of the present invention is to provide an improved method for display of medical 3D image data on a monitor.

In particular, improved image representations should thus be generated with the inventive method, or the images stored in the volume data set should be presented as slices in an improved manner.

The object is achieved in accordance with the invention by a method wherein a rotation center is established in the 3D image data such that an imaginary point, namely its spatial coordinates, are established as the rotation center in the coordinate system of the 3D image data, meaning that all rotations of the 3D image data relative to their observation/representation viewpoints (aspects) ensue around this rotation center. At least two windows are shown on the monitor, respectively showing views of the 3D image data that differ in each of different pairs of the windows. The views are arranged in the windows such that the imaging locations of the rotation center in the respective windows are above one another or next to one another with the same height, relative to the monitor. A rotation axis intersecting the rotation center in the 3D image data is associated with each window. The view in each window can be rotationally altered only by rotating the 3D image data around the rotation axis associated with that window. The view in a first of the windows is changed by manipulating an operating element associated with a second of the windows.

The various viewing points that are shown in the respective windows allow the respective 3D image data therein to be considered or presented from a different viewing direction. The 3D image data are depicted in the windows as views such that the rotation center is visible in each of the windows. In the event that said rotation center lies outside of the region presented in the window, it still can be assumed to lie above or to the side of the monitor in an imaginary enlarged view.

The position with regard to the monitor is understood as meaning that each monitor normally represents an essentially rectangular area to which (for example, given vertical mounting) a lateral dimension and a height dimension are thus to be ascribed. The screen edges thus run vertically and horizontally. Points situated over one another or next to one another relative to the monitor are then arranged parallel to the respective monitor edges.

A layout (format) on the monitor that serves for simultaneous representation of a number of views from various viewing directions of the 3D image data in various windows, or sub-windows of the screen representation is thus generated by the inventive method. Specifically adapted interactions that limit the often confusing arbitrary rotation and displacement freedom are offered to the viewer of the monitor through the severely limited possibility of the representation alteration, namely only a single rotation of a view in one of the sub-windows. The image impression for the observer thereby remains close to the customary standard setting. The views (thus representations of the 3D image data in the windows or, respectively, the sub-windows) are thus simpler and more quickly recognized and more quickly interpreted. The handling of the 3D image data is significantly improved. Since the change of the view in a first window ensues via an operating (control) element that is associated with a second operating window, a coupling of the handling and the display of various windows occurs. In this coupling, as well the degrees of freedom for the adaptation of the screen presentation are limited and the visualization is thereby simplified.

By these measures it is ensured that, given the variation of the image content in a first of the windows, the image contents can remain unchanged in the remaining windows. The viewer of the monitor thus receives complete control over the viewing direction of the representations of the 3D image data.

The inventive method is in principle suitable for all 3D representation methods and is suitable for MPR representation, which is often radiologically preferable.

The rotation center in the 3D image data can be displaced to change the view. In contrast to the rotation around said rotation axis, this leads to a displacement of the portions of the medical 3D image data or their representation on the monitor. The view is thus displaced in a volume in the manner of a 3D translation. For example, if a slice representation through the 3D image data is performed in a window, this can display a slice from a different depth of the 3D volume of the 3D image data.

Alternatively or additionally, the rotation axis in the 3D image data can also be rotated within the image plane to change the view. This leads to an alteration of the angle of the viewing direction toward the 3D image data, and thus also to an altered view in at least one of the other windows.

The operating element associated with the second window can be arranged in the second window. The operating element in the second window thus can also be linked directly with the 3D image data, for example, and the position and orientation of the first window that is altered by the operating element can be visualized in the second window. The manner that the observer has changed the view by movement of the operating element thus is unambiguously signaled to the observer of the monitor.

A preferred viewing direction can be associated with the window, and the view in the window can be changed only within a limited angle range around the viewing direction. For each window the viewer thus immediately recognizes which viewing direction with regard to the 3D image data is available in a corresponding window. The movement capability of the 3D volume with regard to the views is also limited, which contributes to a clear, quickly understandable presentation of the views on the monitor. The viewing direction for each thus window is at least roughly predetermined for the observer and the observer can adapt or alter this only in a certain range.

The angle range can be <±90° or a maximum of ±80°. For an arrangement with three sub-windows and three orthogonal viewing directions, each of these viewing directions is hard-linked with one of the windows; duplicate presentations in the windows are avoided, meaning that a view from a first window can never be presented in a second window, even through a maximum rotation of the views by the viewer.

The viewing direction can be a viewing direction that is customary for a viewer and can be selected dependent on the observer. Physicians who are accustomed to specific viewing directions of patients due to their long years of working with 2D images are often viewers of the monitor. Such a customary viewing direction can be preset for the observer on the monitor or in the window, such that the observer is always shown the customary view on the monitor and this view can possibly be varied only within specific limits.

The viewing direction can likewise be a viewing direction customary for a medical procedure to be implemented using the 3D image data. For example, standard radioscopy images from very specific viewing directions are acquired for specific medical procedures. This viewing direction toward the 3D image data can likewise be preset as a window view and thus likewise represents a customary view for the observer. Frequently-used viewing directions are hereby frontal, axial, lateral, LAO or RAO viewing directions, the latter two at 45° from the front. Such angled views are the predominant viewing perspective in certain situations.

The viewing directions of the views in the windows can be oriented perpendicularly to one another, at least in the initial situation. In particular, given three windows, three views that are orthogonal to one another are presented on the monitor. Image contents for the individual windows thus can be associated with one another in a conventional manner. Moreover such views are thoroughly conventional for an observer (for example, a physician).

The windows on the monitor can be arranged in the manner of the views for DIN normal projection (DIN 6-1 (DIN ISO 5456-2)) of a technical drawing. The interpretation of image contents arranged next to one another or below one another can thus be assisted by an imaginary tilting of the image content or of the 3D image data. The interpretation of the 3D image data shown on the monitor is also thereby intuitively simplified.

It is then particularly advantageous to display three windows on the monitor.

In such an arrangement, a frontal view of the 3D image data, laterally next to this a lateral view, and above or below the frontal view an axial view can be arranged on the monitor. This essentially corresponds to the aforementioned DIN normal projection wherein “lateral” and “above” or “below” are again understood in the sense of the aforementioned definition of the monitor edges.

In at least two of the windows, a crosshair centered in the rotation center can be shown. The rotation center is thereby visualized in the 3D image data; and a view in one window can be visualized in another window by corresponding existing crosshair lines in various windows. For example, the line of a crosshair in a window can be the section line for the representation of the image content of another window. The degree of freedom of the corresponding possible variations of an aspect is thus also visualized.

The crosshair can be the operating element in a first window. The view in a second window is then affected by the operation of the crosshair in another window. Since the monitor presentation normally occurs on a computer workstation, the operator, for example, can move or manipulate the crosshair with a computer mouse. Given displacement of the rotation center in the 3D image data, the crosshair as an operating element in the screen representation consequentially is also shifted.

Alternatively, the crosshair can be stationary in the window and the view can be displaced and/or rotated relative to the crosshair. The 3D volume displayed in the windows can thereby be rotated itself.

The presented 3D image data can serve as an operating element in the window for rotation of the 3D image data or views. For example, the observer then manipulates the 3D image data with the aforementioned mouse rather than the crosshair, for example displayed body tissue of a patient is manipulated directly such that the view or views is/are displaced or rotated.

A first of the windows can be provided with an identifier and an indicator representing the view of the first window can be presented with the same identification in a second of the windows. Such an indicator again visualizes the viewing aspect of the first window, for example in the form of a section line or in the form of a viewing arrow. The identifier serves to visualize which indicator belongs to which viewing aspect, in particular given a number of viewing aspects.

The identifier can be a color identifier. For example, one window can be given a colored border and, in a neighboring window, an indicator in the same color can visualize the respective viewing aspect that is seen in the color-bordered window.

The indicator can be a section line when a corresponding section is shown in the first window.

The views in the windows can remain unchanged during the operation of the operating element. Overall this leads to a smoother presentation on the monitor since the operating of the operating element does not automatically influence the view. This is, for example, accomplished by a crosshair (for example a section line) in a sub-window being moved by pressing a mouse button, and that the view influenced by the altered section line is altered only in another sub-window after releasing the mouse button and thus fixing the new section line.

### BRIEF DESCRIPTION OF THE DRAWINGS

FIG. 1 shows a computer monitor with three windows for presentation of three views of 3D image data of a patient.

FIG. 2 shows the windows of FIG. 1 with an altered lateral view.

FIG. 3 shows the windows of FIG. 2 with an altered frontal view.

FIG. 4 shows the windows of FIG. 3 in altered views.

FIG. 5 shows the windows of FIG. 4 with a displayed metal plate.

### DESCRIPTION OF THE PREFERRED EMBODIMENTS

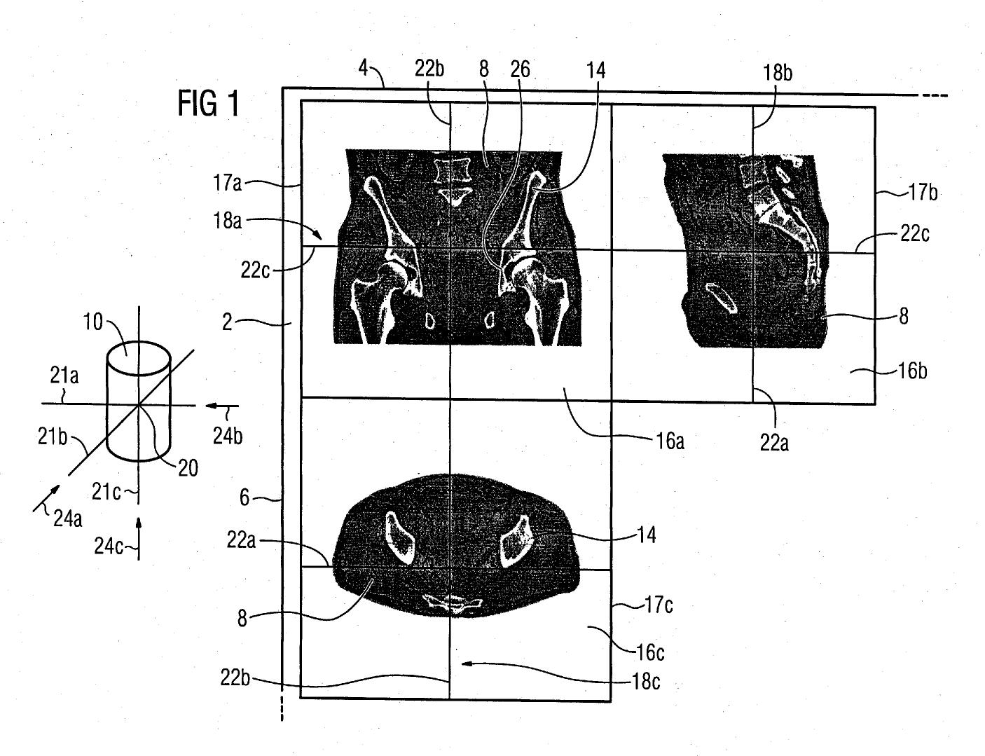

FIG. 1 shows a section of a monitor 2 of a medical computerized imaging system (not shown). The monitor 2 is proportioned such that its upper monitor edge 4 proceeds horizontally and its lateral monitor edge 6 proceeds approximately vertically. The monitor 2 serves for preoperative planning for a physician (not shown) who has acquired a three-dimensional image data set of a patient 8 in the form of 3D image data 10 by a computerized tomography. The physician wants to adapt a metal plate 12 (not shown in FIG. 1) to the left pelvic bone 14 of the patient 8 with the aid of the 3D image data 10.

From past experience the physician is accustomed to execute this procedure using two frontal and lateral 2D x-ray exposures (not shown) of the patient. However, in the present example this is executed using the 3D image data 10. Therefore MPR representations of the 3D image data 10 are presented in three windows 16a-16c on the monitor 2. The window 16a which shows a frontal view of the patient 8 is shown in the left upper corner of the monitor 2; arranged to the right next to this is the window 16b which shows a lateral view of the patient 8, and shown below the window 16a is the window 16c which shows an axial view of the patient 8. Crosshairs 18a-18c which are spatially arranged in the 3D image data 10 and have a center coinciding with a rotation center 20 in the 3D image data 10, are associated with the respective windows 16a-16c.

The MPR representations in the windows 16a-16c are representations with a suitable slice thickness which respectively correspond to slices through the 3D image data 10 along the crosshair axes of the crosshairs 18a-18c. The frontal view in window 16a thus corresponds to a slice through the window 16b or 16c along the section line 22a which forms a portion of the crosshairs 18a-18c in the windows 16b and 16c. The lateral representation in the window 16b corresponds to a representation along the slice line 22b and the representation in the window 16c corresponds to a slice along the section line 22c. The representations in the windows 16a-16c therefore show views of the 3D image data 10 that are represented by corresponding arrows 24a-24c in FIG. 1. Both the corresponding windows (each with a respective frame 17a-17c) and the associated section lines 22a-22c are identified in color for clarification of which section lines 22a-22c hereby correspond to which windows 16a-16c.

The views are arranged in the windows 16a-16c such that the rotation centers 20 of the 3D image data 10 (indicated by the respective intersection point of the crosshairs 18 or section lines 22a-22c) respectively lie horizontally or vertically next to one another or atop one another in the windows 16a-16b, thus (in other words) run parallel to the edges 4, 6.

The physician controls the views of the 3D image data 10 on the monitor 2 using a computer mouse (not shown) or its mouse pointer (not show) on the monitor 2. The physician operates the section line 22b in the window 16a with the mouse pointer in order to place this on the placement surface 26 of the pelvis 14.

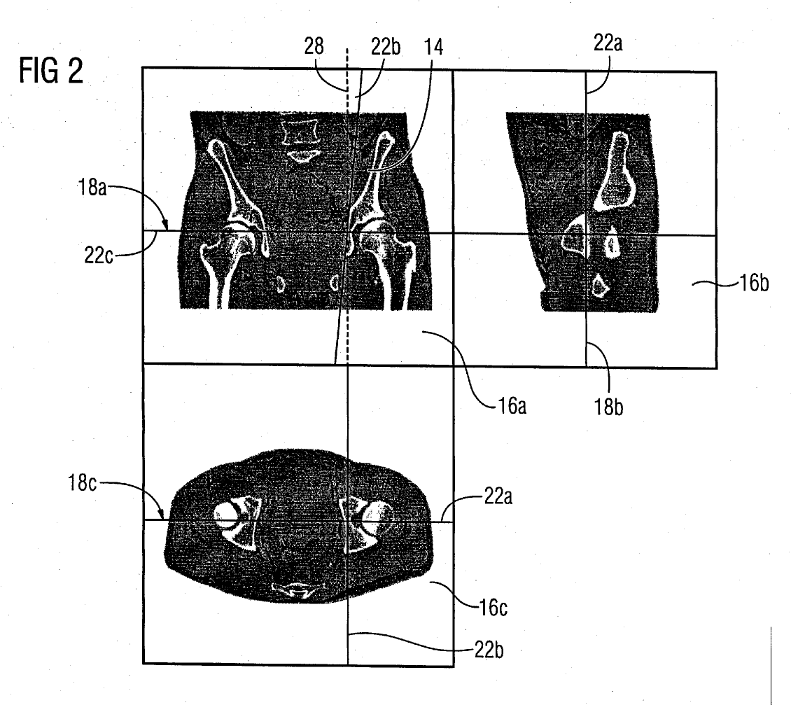

FIG. 2 shows the section line 22b correspondingly displaced and rotated relative to FIG. 1. The section line 22b is slanted to the right in window 16a. This means that the upper part of this section line 22b is located further in the left body region of the patient 8, such that (in the case of the MPR representation in the window 16b) an oblique slice through the body of the patient results from the lower right to the upper left. The upper region of the volume representation of the patient 8 in the right sub-window 16b thus slants away from the observer since in this view the patient 8 is looking to the left. Since only a single rotation (tilting of the section line 22b, thus rotation around the rotation axis 21a) per sub-window is allowed, the horizontal orientation line or section line 22c in the window 16a always remains horizontal.

The views along the arrows 24a and 24c, thus the window contents of the windows 16a, 16c, remain unchanged while the lateral view in the window 16b changes due to the displaced section line 22b. The section line 22b is thus now situated optimally on the pelvic bone 14. With a suitable tolerance or for a suitable slice thickness of the MPR representation, the bone surface in the window 16b is now presented optimally situated in the image plane. Section line 22 has also been displaced to the right in the window 16c due to the shifting of section line 22b in the window 16a. However, the intersection points of the corresponding crosshairs 18a-18c always still lie perpendicularly atop one another (indicated by the dashed line 28), such that all image contents of the windows 16a-16c are furthermore spatially correlated.

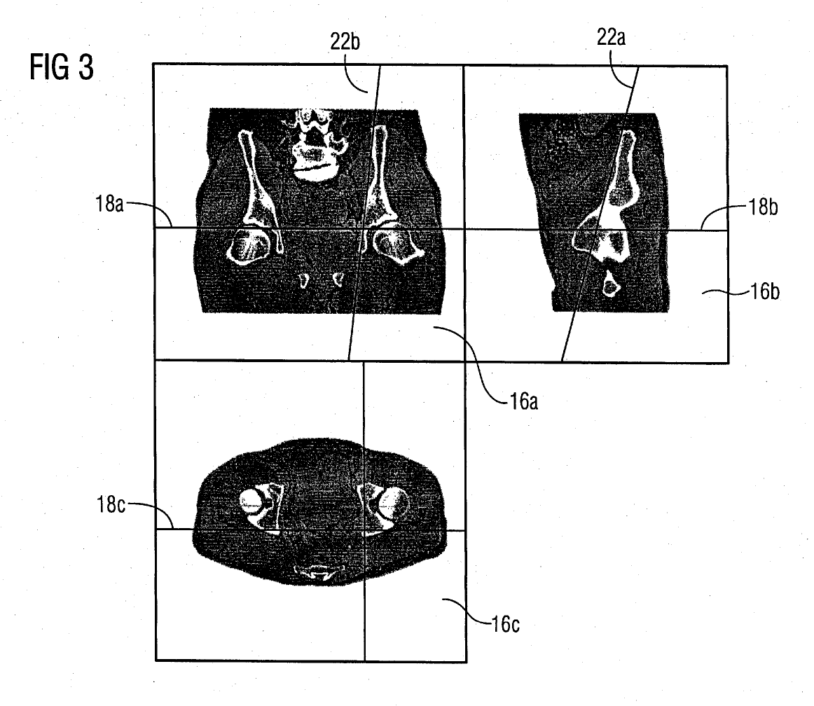

FIG. 3 shows how, starting from the view from FIG. 2, the implant position is adjusted via lateral displacement and rotation via successive operation of the section lines 22a, 22b. This is achieved via further fine movements of the section line 22b in the window 16a and the section line 22a in the window 16b. Since the result of the image representation on the monitor 2 is not yet entirely satisfactory, the vertical section line 22a in the window 16b is tilted, which causes a corresponding slanting of the volume representation of the patient 8 in the window 16a. Since the image representation on the monitor 2 has moved out of the focus of the medical interest (namely the corresponding pelvic bone 14) by the rotation, the image must be readjusted further.

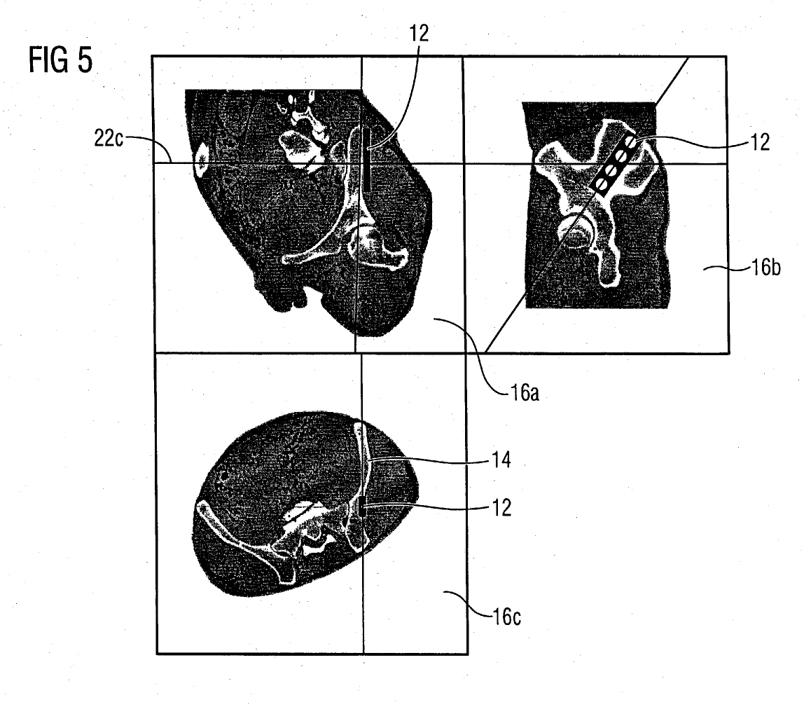

For example, for this purpose the center of the crosshair 18b is also moved upwardly and to the left in the sub-window 16b. This causes an alteration of the slice selection in the sub-window 16a to the front or, respectively, angled towards the front relative to the patient 8. For the simultaneous height variation it is proposed that the volume representations always remain centered laterally as well as with regard to the center of the scaled volume region (thus the 3D image data 10), which remains virtually at half of the height of the sub-windows. While window 16c thus always shows a horizontal slice representation of the 3D image data 10 in FIG. 3, both the original frontal and lateral views of the patient 8 in the windows 16a and 16b are tilted in the meanwhile. According to FIG. 3, the position and orientation of the metal plate 12 thus finally results directly from the bearing of the intersection points of the crosshairs 18a-18c, or from the course of the section lines 22a-22c. For example, the intersection point of the crosshairs 18a-c can hereby respectively be defined as a center of the implant, thus of the metal plate 12. As can be seen in FIG. 5, the metal plate 12 itself can alternatively or additionally also be shown as well in the windows 16a-c. This can ensue either during or after occurred positioning as described in connection with FIGS. 1 through 3.

Orthopedically, it can be advantageous to mount the metal plate 12 predominantly vertically but angled laterally. For this purpose, the third sub-window 16c on the monitor 2 can also be correspondingly altered.

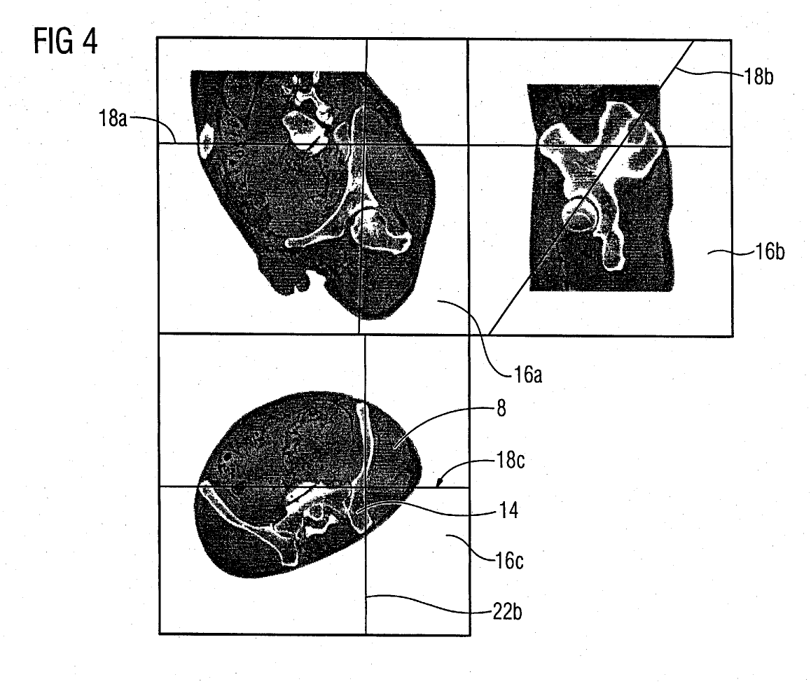

FIG. 4 shows how the axial view (arrow 24c), thus viewed from the feet of the patient 8 to the head), is directly moved with the mouse pointer. The mouse pointer is hereby positioned at an arbitrary point of the representation of the body of the patient 8 in the sub-window 16c and this is virtually picked and manipulated, i.e., (thus) rotated around the intersection point of the crosshair 18. This rotation is continued until the section line 22b (and therewith the transverse axis of the metal plate 12) is situated close to the pelvis 14. The plate therewith also lies in the image plane of the sub-window 16b. The sub-window 16a shows a view in the direction of the transverse implant axis, such that the adaptation henceforth can again ensue corresponding to the adaptation described in connection with FIGS. 1-3 (thus the frontal-lateral situation). The adaptation (thus further fine adjustment of the section lines 22a-22c) will again ensue successively, iteratively in the windows.

In an alternative, a corresponding graphical operating element (which is not shown in FIG. 4) in the manner of a virtual “handle” could also be faded in for the rotation of the image in the window 16c, which handle can be picked or manipulated with the operation via the computer mouse. The rotation around the rotation axis 21c can thus alternatively likewise be executed in, for example, a DICOM coordinate system which applies for the 3D volume 10. The original existing lateral or frontal views of the sub-windows 16b and 16a can also transform via the rotation in the LAO or RAO orientation in the sub-window 16c.

FIG. 5 shows the situation after a performed external adaptation of a plate to the pelvis 14, with the metal plate shown in an oblique 3D representation.

An alternative (not shown) to the slice representation in the case of MPRs would be a different type of spatially-dependent selection in other 3D representation techniques, for example geometric clipping in the case of volume rendering.

In all of FIGS. 1-5 only a single rotation (thus a single movement of a section line 22a-22c) is allowed in the sub-windows 16a-16c. For example, the section line 22c in the two upper windows 16a and 16b remains continuous and horizontal. The focus of the medical interest can be displaced via the position tracking of the respective intersection points of the crosshairs 18. This causes an alteration of the slice selection from the 3D image data 10 as this is visible, for example, in the windows 16c of FIGS. 3 and 4 using the axial slices. By the rotation of the 3D image data 10 in the window 16c of FIG. 5, the views in the windows 16a and b change from axial and lateral towards the LAO and RAO directions.

Although modifications and changes may be suggested by those skilled in the art, it is the intention of the inventor to embody within the patent warranted hereon all changes and modifications as reasonably and properly come within the scope of his contribution to the art.

1. A method for displaying medical 3D image data on a monitor, comprising the steps of:
establishing a rotation center in the 3D image data;
on the monitor, displaying at least two windows with respectively different views of said 3D image data, said different views also differing for each pair of said at least two windows;
arranging the views in the windows on the monitor such that the respective image locations of the rotation center in the respective windows lie above one another or next to each other relative to the monitor;
associating a rotation axis with each window the intersects the rotation center in the 3D image shown in that window;
allowing rotational modification of the view in each window only by rotating the 3D data in that window around the rotation axis associated with that window; and
changing a view in a first of said windows by manipulation of an operating element associated with a second of the windows.

2. A method as claimed in claim 1 comprising displacing the rotation center in the 3D image data in order to change the view containing the displaced rotation center.

3. A method as claimed in claim 1 comprising changing a view by rotating the rotation axis within the view plane in the view associated therewith.

4. A method as claimed in claim 1 comprising displaying said operating element associated with said second of said windows inside said second of said windows.

5. A method as claimed in claim 1 comprising associating a predetermined, preferred viewing direction with each of said windows, and permitting alteration of the view in the respective windows only within a limited angle range around the preferred viewing direction.

6. A method as claimed in claim 5 wherein said angle range is less than ±90°.

7. A method as claimed in claim 6 wherein said angle range is a maximum of ±80°.

8. A method as claimed in claim 5 comprising selecting said preferred viewing direction as a viewing direction customary for an observer of said 3D image data on the monitor.

9. A method as claimed in claim 5 comprising selecting the preferred viewing direction as a viewing direction that is customary for a medical procedure to be implemented using said 3D image data.

10. A method as claimed in claim 5 comprising selecting said preferred viewing direction from the group of viewing directions consisting of frontal, axial, lateral, LAO and RAO viewing directions.

11. A method as claimed in claim 1 comprising orienting the viewing directions of the respective views in said pairs of windows perpendicularly to each other, at least in an initial position of the 3D data in the pairs of windows.

12. A method as claimed in claim 1 comprising arranging said windows on said monitor according to views in a standardized DIN projection of a technical drawing.

13. A method as claimed in claim 1 comprising displaying three of said windows on said monitor.

14. A method as claimed in claim 13 comprising displaying the 3D image data in the respective 3D windows in a frontal view, a sagittal view laterally next to the frontal view, and an axial view above or below the frontal view.

15. A method as claimed in claim 1 comprising centering a displayed crosshair at the rotation center in said at least two of the windows.

16. A method as claimed in claim 14 comprising using said crosshair as said operating element.

17. A method as claimed in claim 15 comprising maintaining said crosshair stationary in the window and displacing or rotating the view in that window relative to the crosshair.

18. A method as claimed in claim 1 comprising employing the displayed 3D image data in said second of said windows as said operating element.

19. A method as claimed in claim 1 comprising providing an identifier in said first of said windows, and providing an indicator in said second of said windows representing the view of the first window with the same identifier.

20. A method as claimed in claim 18 comprising using a color identifier as said identifier.

21. A method as claimed in claim 18 comprising using a section line as said identifier.

22. A method as claimed in claim 1 comprising maintaining views in windows other than said first of said windows unchanged during manipulation of said operating element.
